(19) United States
(12) Patent Application Publication
(10) Pub. No.: US 2012/0184143 A1
(43) Pub. Date: Jul. 19, 2012

(54) SECURING STRUCTURE OF A COVER FOR AN ELECTRIC CONNECTOR

(75) Inventor: Li-Yun Lai, Panchiao (TW)

(73) Assignee: ALEX CONNECTOR CO., LTD., Panchiao (TW)

(21) Appl. No.: 13/007,999

(22) Filed: Jan. 17, 2011

(51) Int. Cl. H01R 13/46

(52) U.S. Cl. 439/625

(57) ABSTRACT

The present invention relates to a cover-fastening structure of an electrical connector. The electrical connector has a base and a cover. The cover is connected to one side of the base. One side of the base is connected to the cover through a connecting portion, so that the cover is and the base can be integrally connected together. In this way, the molding of the cover and the base is integrated and the manufacturing process of the electrical connector is simplified.

### BACKGROUND OF THE INVENTION

1. Field of the Invention

The present invention relates to a cover-fastening structure of an electrical connector. The electrical connector is integrally formed with a cover and a base. In this way, the molding of the cover and the base is integrated and the manufacturing process of the electrical connector is simplified.

2. Description of Prior Art

With the advancement of science and technology, computers have been widely used in our daily life and work. In order to maintain the operation quality of the computer, it is necessary to provide a stable power supply.

A mother board of the computer is a circuit board on which a plurality of electrical connectors is electrically connected with a power supply. In each electrical connector, a plurality of terminals is provided. In order to protect the terminals in the electrical connector, an openable cover is provided. Please refer to FIG. 1. Taiwan Patent No. M292186 discloses an electrical connector 10 having a base 100. A plurality of terminals 102 is disposed into the base 100. In order to protect the terminals 102, an upper cover 101 is slidingly disposed provided on one side of the base 100, and the upper cover 101 covers atop of the base 100. The upper cover 101 is configured to protect the terminals 102, however, the manufacturing of such an electrical connector 10 inevitably needs increased molds and cost. The slidable upper cover 101 may be loosened and even get lost. Thus, due to the above-mentioned cover, it is difficult to reduce the cost and maintenance of the conventional electrical connector.

In view of the above, the present inventor proposes a novel cover-fastening structure of an electrical connector, in which one side of the base of the electrical connector is connected with a cover having a plurality of fasteners. The cover rotates 180 degrees with respect to the cover to cover on the base by using one side of the cover as a center of rotation. The cover and the base are integrally formed as a body, so that the molding of the cover and the base is integrated and the manufacturing process of the electrical connector is simplified.

### SUMMARY OF THE INVENTION

A primary objective of the present invention is to provide a cover-fastening structure of an electrical connector, in which one side of the cover is connected with the base.

Another objective of the present invention is to provide a cover-fastening structure of an electrical connector, in which a connecting portion is formed between the cover and the base.

A further objective of the present invention is to provide a cover-fastening structure of an electrical connector, in which one side of the cover is formed with fasteners each having a fastening hole.

A still further objective of the present invention is to provide a cover-fastening structure of an electrical connector, in which one side of the cover is formed with an extension portion.

A still further objective of the present invention is to provide a cover-fastening structure of an electrical connector, in which one side of the base is formed with troughs each having a protrusion.

The detailed description and technical contents of the present invention will be described in more detail with reference to preferred embodiment thereof shown in the accompanying drawings

### BRIEF DESCRIPTION OF THE DRAWINGS

FIG. 1 is a schematic view showing a conventional electrical connector combined with a cover;

FIG. 2 is a perspective view showing a cover-fastening structure of an electrical connector according to the present invention;

FIG. 3 is a perspective view showing the cover-fastening structure of an electrical connector according to the present invention, in which the cover is open;

FIG. 4 is a perspective view showing the cover-fastening structure of an electrical connector according to the present invention, in which an extension portion of the cover is provided;

FIG. 5 is a perspective view showing the cover-fastening structure of an electrical connector according to the present invention, in which the cover is fastened to the base; and

FIGS. 6A to 6L are schematic views showing different embodiments of the cover-fastening structure of an electrical connector according to the present invention.

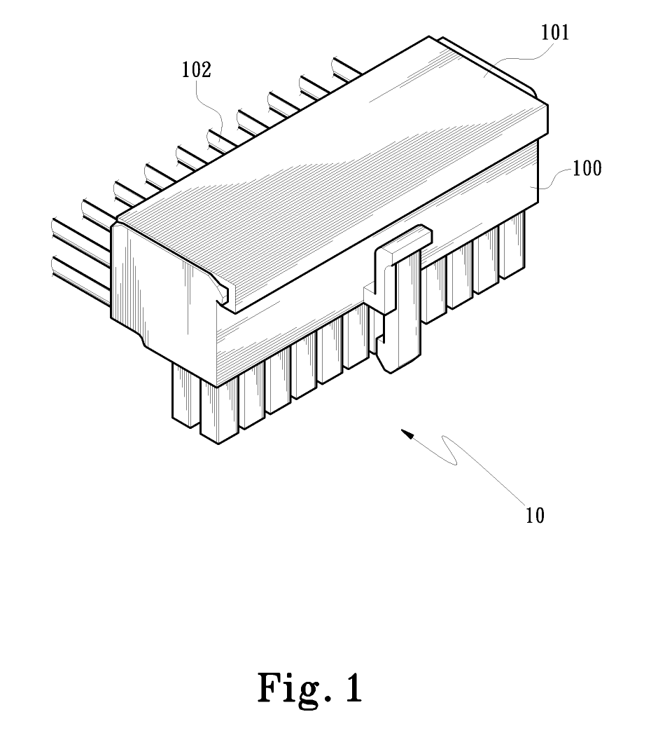

### DETAILED DESCRIPTION OF THE INVENTION

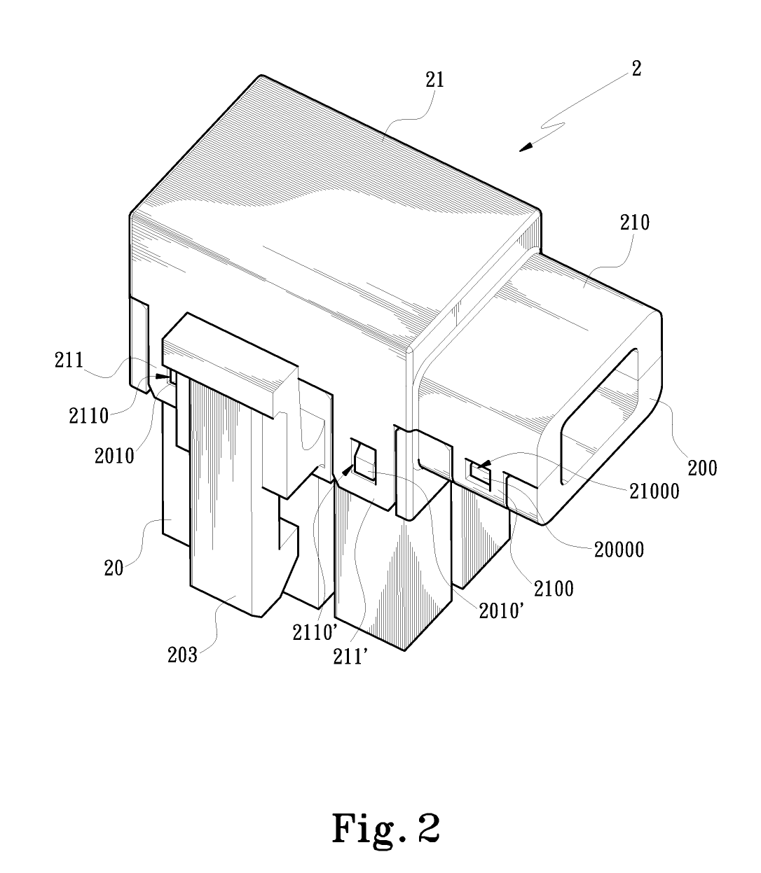

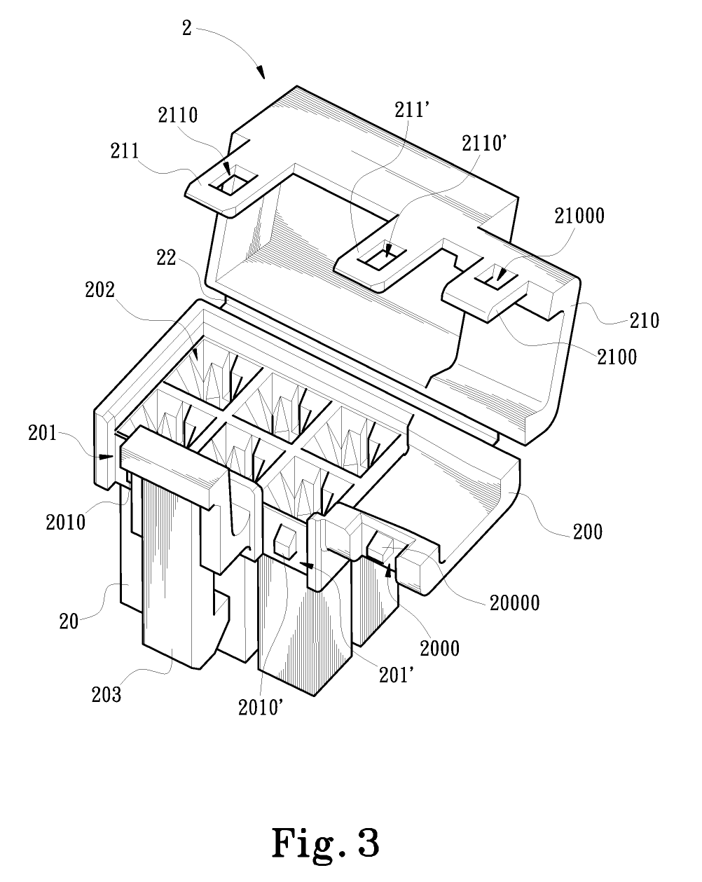

Please refer to FIGS. 2 and 3. The present invention provides a cover-fastening structure of an electrical connector. The electrical connector 2 includes a base 20 and a cover 21 connected to one side of the base 20. The cover 21 is rotatably fastened to the base 20, so that the cover 21 and the base 20 of the electrical connector 2 can be integrally formed into one body.

The base 20 is substantially formed into a rectangular body having an opening on its one side. A plurality of through slots 202 is formed in the base 20. One side of the base 20 is formed with a U-shaped extension portion 200. On the same side of the extension portion 200, the base 20 is further formed with a connecting portion 22 through which the base 20 is connected to the cover 21. A vertical outer surface of one side of the base 20 is formed with a J-shaped clamping element 203. The outer surface of both sides of the clamping element 203 are formed with a trough 201, 201′ respectively. The center of the trough 201, 201′ is formed with a protrusion 2010, 2010′ respectively to correspond to a fastening hole 2220, 2110′ of a fastener 211, 211′ of the cover 21. The fastener 211, 211′ is engaged within the trough 201, 201′, so that the vertical outer surface of the cover 21 can be formed into a smooth plane.

The vertical outer surface on one side of the extension portion 200 of the base 20 is formed with a trough 2000. The center of the trough 2000 is formed with a protrusion 20000 to correspond to a fastening hole 21000 of a fastener 2100 of an extension portion 210 of the cover 21. The fastener 2100 is engaged within the trough 2000, so that the vertical outer surface of the cover 21 can be formed into a smooth plane.

The cover 21 is substantially formed into an inverted U-shape body. One side of the cover 21 is formed with the U-shaped extension portion 210. One side of the cover 21 is connected to the base 20 through the connecting portion 22, so that the cover 21 is rotatably fastened to the top surface of the base 20. One side of the extension portion 210 of the cover 21 is formed with a plurality of fasteners 211, 211′, 2100 each having a fastening hole 2110, 2110′, 21000. The fastener 211, 211′ is located to correspond to the trough 201, 201′ of the base 20. The fastening portion 2100 of the extension portion 210 of the cover 21 is located to correspond to the trough 2000 on one side of the extension portion 200 of the base 20. The fastening hole 2110, 2110′, 21000 of the fastener 211, 211′, 2100 is engaged with the protrusion 2010, 2010′, 20000 in the trough 201, 201′, 2000 of one side of the base 20, so that the cover 21 can be fastened to the base 20 easily. In this way, the molding of the cover 21 and the base 20 is integrated and the manufacturing process of the electrical connector 2 is simplified.

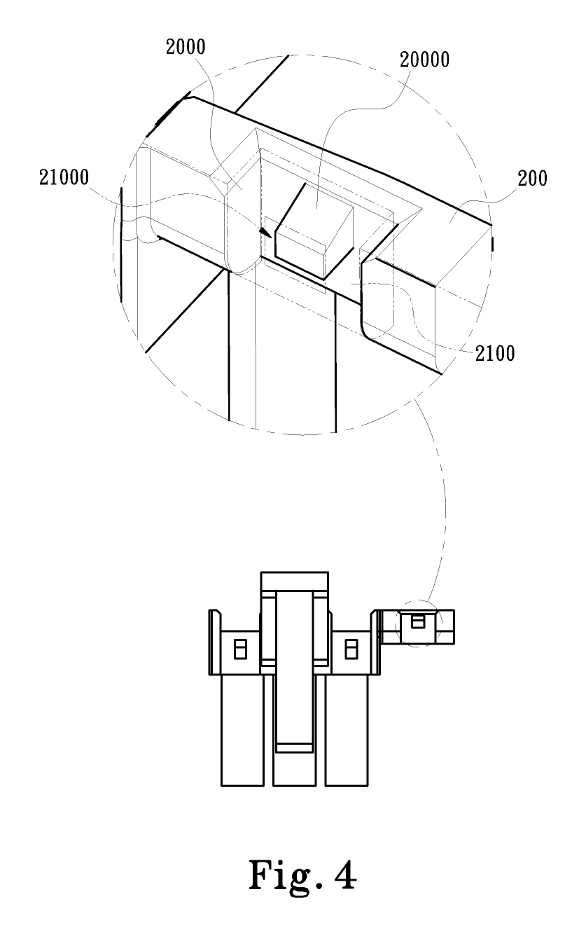

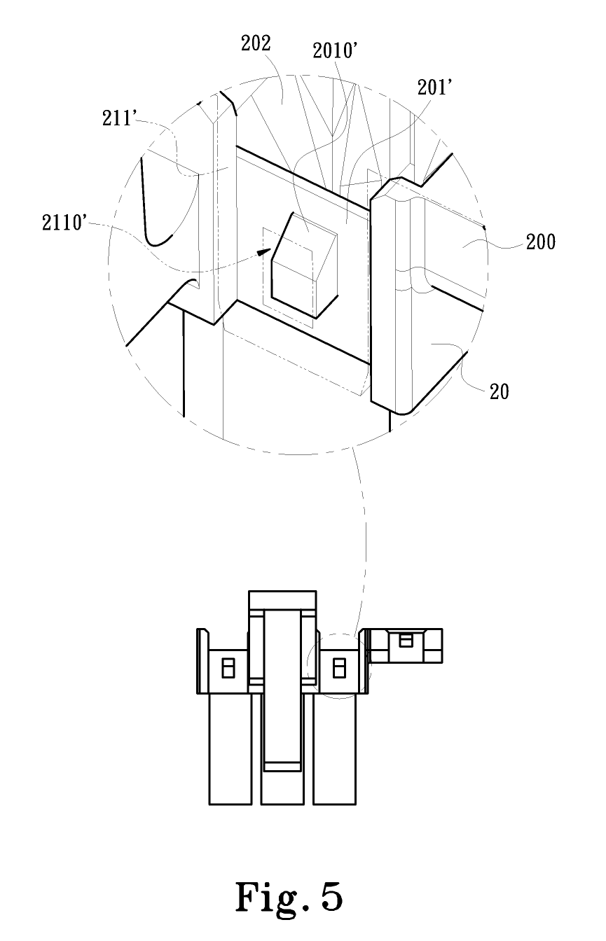

Please refer to FIGS. 4 and 5 showing the cover-fastening structure of an electrical connector according to the present invention, in which the cover 21 is fastened to the base 20. One side of the base 20 is connected to the cover 21 through the connecting portion 22. One side of the extension portion 210 of the cover 21 extends to form a plurality of fasteners 211, 211′, 2100 each having a fastening hole 2110, 2110′, 21000. The vertical outer surface on one side of the extension portion 200 of the base 20 is formed with a plurality of troughs 201, 201′, 2000 each having a protrusion 201, 201′, 2000. When the cover 21 covers the base 20, the fastener 211, 211′, 2100 of the extension portion 210 of the cover 21 is respectively fastened to the trough 201, 201′, 2000 of the extension portion 200 of the base 20 in such a manner that the fastening hole 2110, 2110′, 21000 is engaged with the protrusion 2010, 2010′, 20000. With the insertion of the fastener 211, 211′, 2100, both side surfaces of the trough 201, 201′, 2000 become a smooth plane. In this way, the external appearance of the electrical connector 2 is improved greatly.

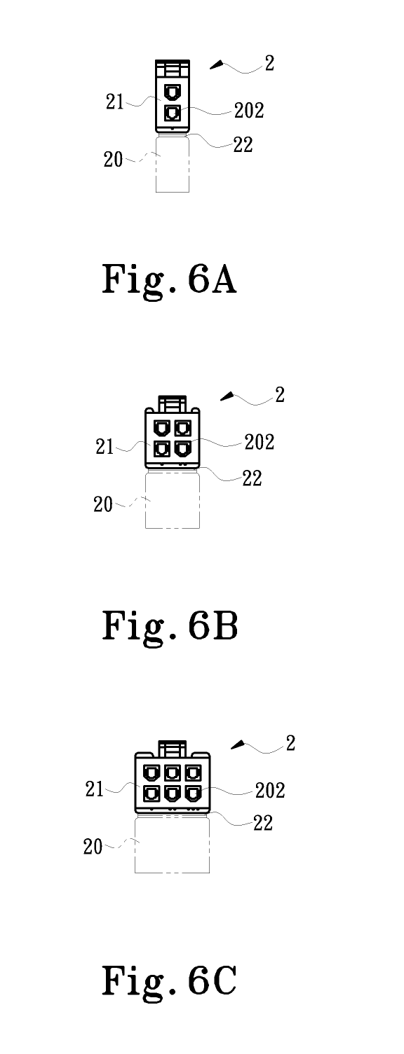

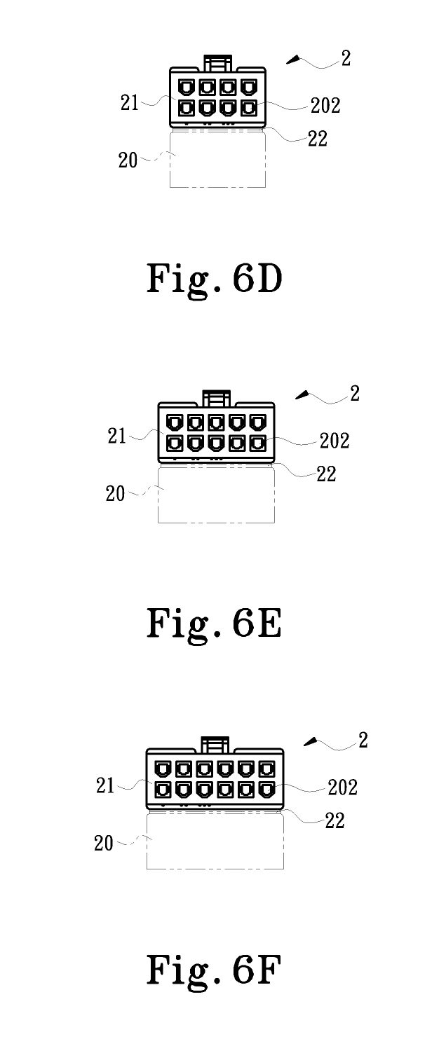

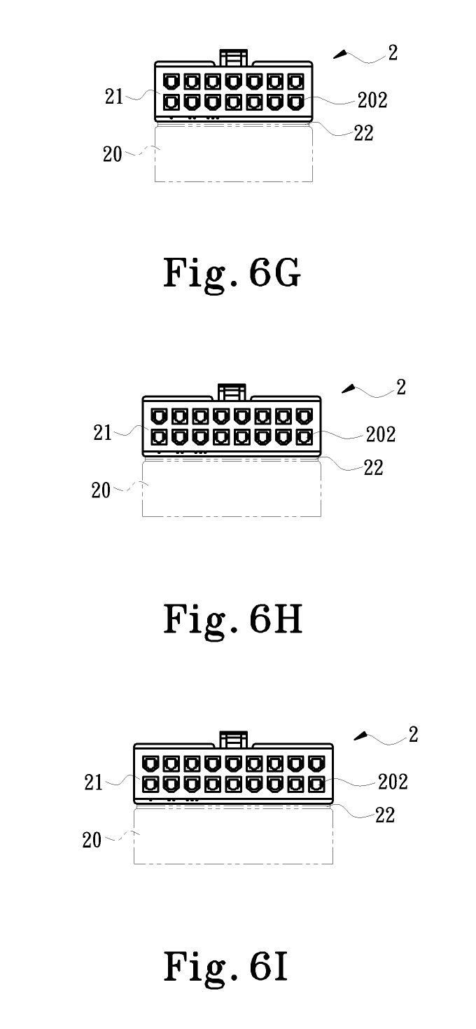

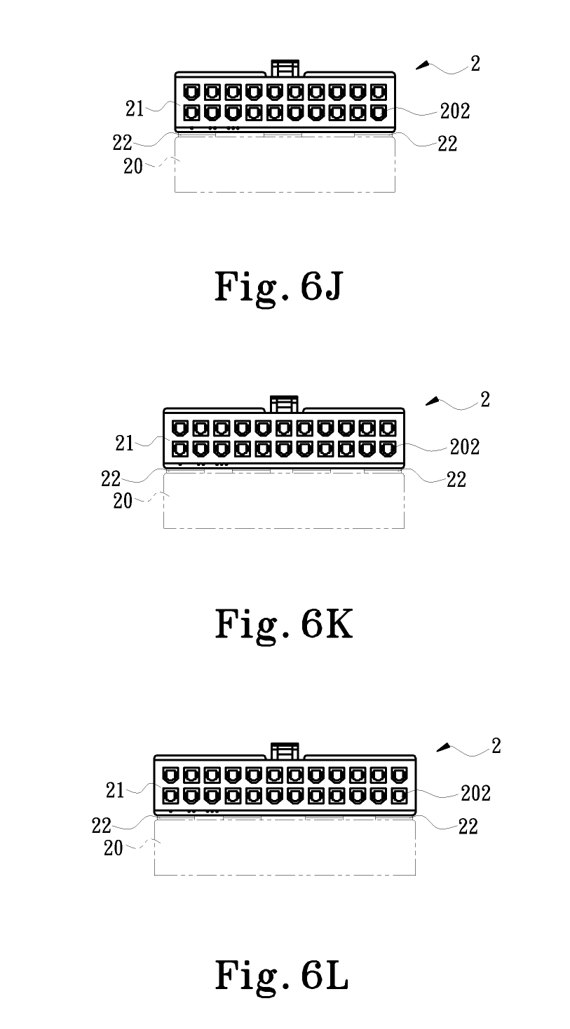

Please refer to FIGS. 6A to 6L showing different embodiments of the cover in the cover-fastening structure of an electrical connector according to the present invention, in which the cover 21 is connected to one side of the base 20 through the connecting portion 22. In the best embodiment, the base 20 is provided with six through slots 202. In practice, any two even number of through slots 202 may be formed in the base 20. As shown in FIGS. 6J to 6L, at least one connecting portion 22 is provided to connect the base 20 and the cover 21. Thus, the cover 21 can be connected to various kinds of bases 20 to achieve a firm connection with a good external appearance.

What is claimed is:

1. A cover-fastening structure of an electrical connector, including:
a base having a plurality of through slots, a side of the base being connected with a cover through a connecting portion, a vertical outer surface of a side of the base being formed with at least a trough having a protrusion; and
a connecting portion configured to connect the base and the cover;
wherein the cover has a side connected to the base through the connecting portion, and a side of the cover is formed with at least a fastener having a fastening hole,
characterized in that:
a side of the base is connected to the cover through the connecting portion, the fastening hole of the fastener is engaged with the protrusion of the trough, whereby the cover and the base are integrally connected together.

2. The cover-fastening structure of an electrical connector according to claim 1, wherein a side of the base is formed with an extension portion, and a side of the extension portion is formed with the trough having the protrusion.

3. The cover-fastening structure of an electrical connector according to claim 1, wherein a side of the cover is formed with an extension portion, and a side of the extension portion comprises the fastener having the fastening hole.

4. The cover-fastening structure of an electrical connector according to claim 1, wherein at least one connecting portion is provided.
